(19) United States
(12) Patent Application Publication
(10) Pub. No.: US 2016/0110934 A1
(43) Pub. Date: Apr. 21, 2016

(54) Automated Vehicle Health & Maintenance Predictor

(71) Applicants: Joseph J. ERNST, Portland, OR (US); Mark O. PAUL, Portland, OR (US)

(72) Inventors: Joseph J. ERNST, Portland, OR (US); Mark O. PAUL, Portland, OR (US)

(73) Assignee: AutoAP, Inc., Beaverton, OR (US)

(21) Appl. No.: 14/887,307

(22) Filed: Oct. 19, 2015

Related U.S. Application Data
(60) Provisional application No. 62/066,098, filed on Oct. 20, 2014.

(51) Int. Cl. G07C 5/08; G07C 5/02; G06Q 10/00; G07C 5/00

(52) U.S. Cl. CPC G07C 5/085; G07C 5/006; G07C 5/02; G07C 5/0808; G06Q 10/20

(57) ABSTRACT

Status and maintenance data (including real-time fault information) about mechanical devices such as vehicles, as well as recommended maintenance information and manufacturing/safety-defect information are collected from a range of sources and used to help diagnose system problems. Recommended/preventative maintenance may also be scheduled, and the information is aggregated to enhance device value by providing complete problem, repair and maintenance records.

### CONTINUITY AND CLAIM OF PRIORITY

This U.S. patent application claims priority to U.S. provisional patent application No. 61/066,098 filed 20 Oct. 2014.

### FIELD

The invention relates to automated electronic financial or business practice arrangement. More specifically, the invention relates to a computerized arrangement which enables people to obtain information from their automobile, learn about its state of functionality (for instance, needing regularly maintenance and/or unplanned repair), and automatically be connected with the best-fit match service provider that meets their schedule requirements and repair provider requirements. The invention also relates to future increases in vehicle (car, truck, RV, boat, motorcycle, etc.) value clue to predictive maintenance needs and electronic vehicle and maintenance records.

### BACKGROUND

Often, owners of vehicles don't perform routine scheduled or preventative maintenance on their vehicles because they don't really know when these actions are clue. Nor do people know when something is about to go wrong with their vehicle. Additionally, many factors are considered when determining the market value for a pre-owned motor vehicle. Certain attributes naturally have a quantitative value such as vehicle age or the vehicle's mileage. Other attributes are qualitative in nature and as such are not easily factored into a vehicle's market value calculation. For example, with all other things being equal, a vehicle with all records would be preferable to one with no records. However, vehicles of the same year, make, model, condition, and mileage, may differ widely clue to one motor vehicle Seller including a statement such as “ . . . I have all maintenance records”, or “ . . . always serviced at dealership.” This provides a distinct differentiation from other similar vehicles in the marketplace. However, currently there is no way to accurately compare two or more vehicles with such vague claims.

Often, motor vehicle owners are typically required to perform routine preventative maintenance as well as repair work on their vehicles. It is common practice for them to delay maintenance until well past the manufacturer's recommended interval, or even skip it entirely. Even when the maintenance is not preventative (e.g. worn brake pads, engine fault codes), owners may not know about the problem or have it fixed in a timely manner. This practice can end up costing the owner more money in the long run clue to larger repair bills and reduced vehicle resale value. It also causes lost revenue to service centers when vehicle owners skip recommended maintenance or don't replace faulty parts.

The present invention describes a system and method for increasing a vehicle owners' likelihood of having maintenance and repair work performed on-time, and at a qualified service center.

### SUMMARY

Systems implementing embodiments of the invention leverage data about vehicle ‘state’ (currently or about to require maintenance) to increase the chances that the vehicle owner can optimize their personal schedules as well as optimize the long term value of their vehicle. This enables a person to know what the operational status of their vehicle is and what the operational status of their vehicle will be in the near future. The inventive system can extend (or be extended by) conventional data collection, analysis, optimization and predictor systems support features, and service center schedule-matching so that any combination is unequivocally better than traditional offerings.

### BRIEF DESCRIPTION OF DRAWINGS

FIG. 1 shows an overview of an environment where an embodiment of the invention can be deployed, including a number of typical participating people and devices.

FIG. 2 is a hybrid block/function/entity diagram showing participating elements and their interactions.

FIG. 3 is a flow chart outlining operations of an embodiment.

### DETAILED DESCRIPTION

Embodiments of the invention integrate special- and general-purpose hardware, multiple databases, and scheduling facilities, all interconnected by a distributed data network, to support a number of valuable use cases, detailed below.

By way of example, this application will refer to automobile maintenance and repair, however the scope of this invention covers any mechanical, structural, or other system that requires such maintenance and/or repair work. Examples of such systems include, but are not limited to, motor vehicles, airplanes, boats, mechanical equipment, buildings, homes, etc.

The present invention describes a system and method for quantifying the maintenance history of a mechanical, structural, electrical, or other type of system. The resulting value can then be used to compare two or more similar systems quantitatively as opposed to qualitatively, which historically has been the way these comparisons have been made.

This invention pertains to any system that requires ongoing maintenance, either in the form of preventative maintenance, or repair work. Preventative maintenance is typically performed on some sort of schedule which may be based on time intervals (e.g. “Monthly”) or usage intervals (e.g. “Every 10,000 Miles”). Repair work is typically performed in response to the failure of a component to perform its intended duty.

The present invention describes a system and method for creating a measurable, quantifiable value using information from a number of sources such as the vehicle itself, a service center's records, and the vehicle owner's reported values. Input values are combined and weighted in such a way as to create a single output value that can be compared to other vehicles of a similar nature.

A goal of the present invention is to capture appropriate values from any of the example input sources or any other input sources that may become discovered or created in the future and use mathematical formulae to compute one or more significant output values. In a preferred embodiment, the output value for a vehicle that receives on-time regular scheduled maintenance at a preferred service center should exceed output values for similar vehicles that received late scheduled maintenance, or that received maintenance by someone other than a certified service center. The resulting values may be represented as a simple integer, a percentage, or a tiered ranking system (e.g. “Platinum, Gold, Silver”).

### Components of the System

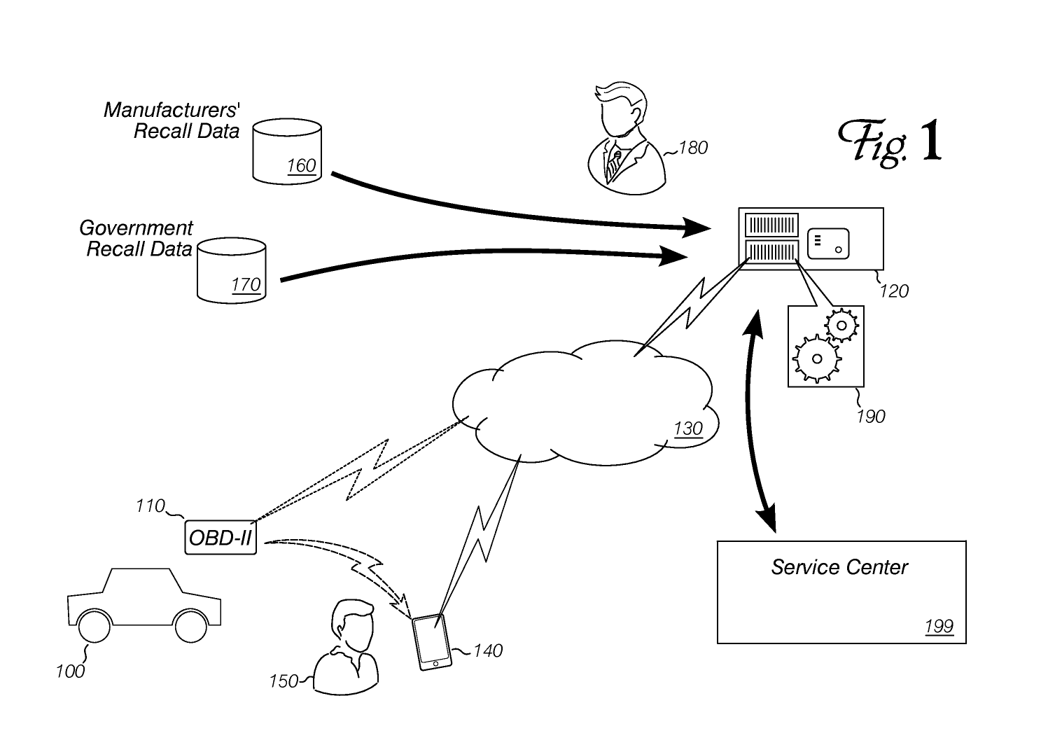

Turning to FIG. 1, an embodiment coordinates communications and activities among a number of participants. According to the example in use, operations are focused on assessing and protecting the value of a vehicle 100. Information about the vehicle may be obtained through an interface device 110 that accesses the vehicle's On Board Diagnostics (“OBD”) system. This information may be transmitted to a computer 120 that performs many central operations of the system via a distributed data network 130 such as the Internet. Information may also (or instead) be transmitted from interface device 110 to an intermediate device such as a cell phone 140 belonging to the vehicle's owner 150, and thence to the central control computer 120.

The system also collects and aggregates data from other sources, such as manufacturers' recall databases 160 and government recall databases 170. The inventors have discovered that these types of data (and others) are often incomplete, inconsistent or even incorrect, so a preferred embodiment includes a manual data cleaning step, performed (for example) by an employee 180 of the operator of the embodiment. The automated operations of the embodiment may be performed by a computer program 190, or by a suite of cooperating programs (not shown), the functions of which may execute on one computer or be distributed among a number of cooperating computers. Finally, the system interacts with a service center 199, which has the resources to maintain and/or repair vehicle 100.

### Input Data Sources

Embodiments can incorporate information from a wide variety of sources:
A motor vehicle's Onboard Diagnostics System (OBD, OBDII, etc)
   Most modern motor vehicles contain a computerized on-board diagnostics system (e.g. OBDII) that has a physical port or other means of supplying the vehicle's telemetry to external systems. For example, the vehicle's mileage and fault codes can be captured from its OBDII port
A supplemental “plugin” module for a motor vehicle's OBD port
   Several manufacturers offer plugin modules that can extend the functionality of a vehicle's native onboard diagnostics capabilities. For example, some plugin modules offer wireless ports to connect to the OBDII via Bluetooth or Wi-Fi, as well as accelerometers to measure impact forces.
A Service Center's electronic records system
   Most service centers maintain electronic records of maintenance and repair work performed on a specific vehicle. Those records typically include important information such as the date the service was performed and the vehicle's mileage.
A Vehicle Owner's own records
   Some vehicle owners prefer to perform their own maintenance and repair work.

The system has several methods of encouraging timely maintenance and/or repair:
1. Real-time explanation of engine fault codes, coupled with automatic communication with a service center. For example, if a vehicle's “Check Engine” light illuminates, it is because of a fault code. The present invention will allow the vehicle to communicate via the owner's mobile device directly to the service center. The service center can send a message back to the owner's mobile device explaining in detail why the “Check Engine” light is on, what needs to be done about it, as well as offering possible appointment dates/times that are also open for the owner, and a discount if service is handled promptly.
2. Notification of factory recalls: Manufacturers' past and future notifications of recalled vehicles.

An embodiment may provide real-time monitoring of vehicle health data to be used to develop a report to the seller for future vehicle value reporting as a function of speed to repair.

An embodiment may also integrate with other systems to provide reporting to a vehicle owner in the way—for example—of scheduled-maintenance reminders.

Additional description/attributes of the system include, but are not limited to:

### Approach

Message to Users
   “Keep your car safe & well-maintained”
   Recall notifications
   Scheduled Maintenance Reminders
   Discounts on all scheduled maintenance (when done at dealer)
“Maximize resale value”
   Show all maintenance records
   Assign a “score” based on performing all preventative maintenance on-time and at the dealer.
Message to Dealers
   “Keep your customers coming back”
   We provide a conduit directly into your customer's smart phones
      Messages tailored to individual's needs
      Cheaper and more effective than direct mail campaigns

### Features

Dashboard (may require an optional OBDII dongle)
   Avg. MPG
   Countdown to next scheduled maintenance (by time or mileage)
   “Check Engine Light”: Show code and provide one-click way to contact service department
Maintenance records
Reminders
   Scheduled maintenance
   Driver's License renewal
   Vehicle registration renewal
   Vehicle safety/smog inspection renewal
Owner's Manual
Call for roadside assistance
Sell your car
Fleet Management
   Connect vehicles to Fleet Management center instead of Dealer

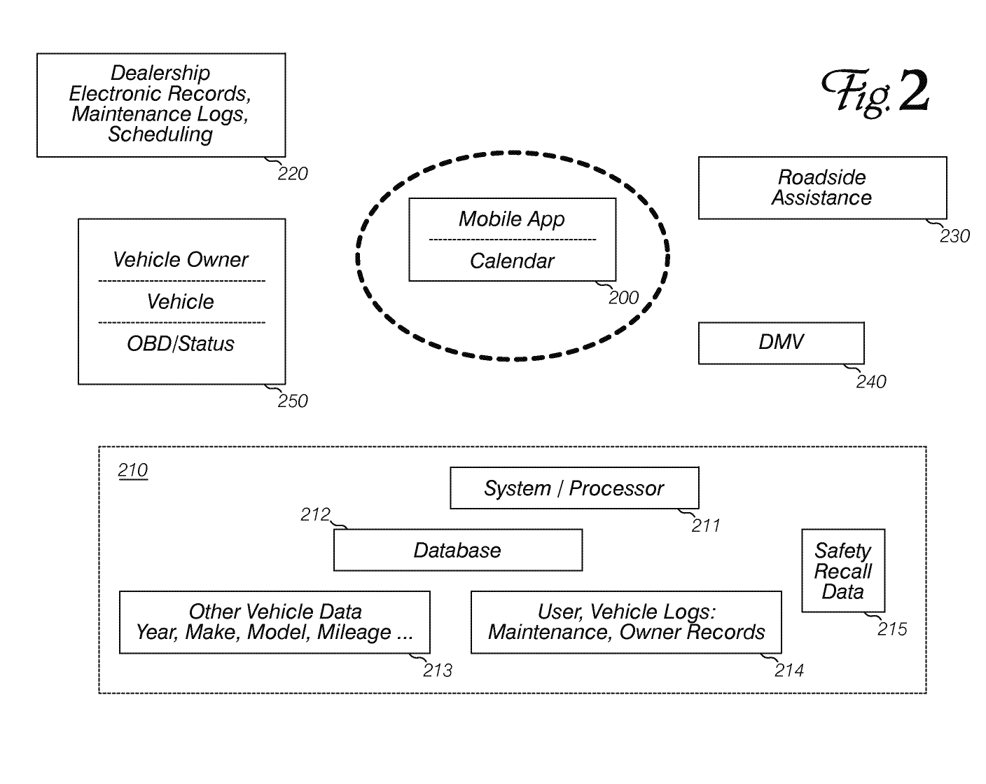

FIG. 2 shows a more detailed view of constituents of an embodiment of the invention. The central point of interest from the user's perspective is the mobile application (“app”) 200, which includes (or integrates with) a calendar feature. This portion of the embodiment is preferably deployed on a portable computing device such as a mobile (cellular) telephone.

For purposes of an embodiment, the mobile application 200 communicates chiefly with the server-side portions 210, including a system processor 211, database 212 (including vehicle data such as make, model, year, mileage, location, maintenance records, etc., 213; and owner data 214), and safety recall data 215 (e.g., manufacturer and government data). Some information is collected from the vehicle and/or owner 250, and the system (either via mobile app 200 or server 210) may interact with a dealership 220, roadside assistance service 230, or even the Department of Motor Vehicles (“DMV”) 240. Communications can be classified as “emergency” or “non-emergency:” for example, a vehicle collision sensor or critical status alert (e.g., low oil pressure) may be considered “emergency,” and may be routed appropriately. Non-emergency communications include scheduled activities such as license and registration renewal (with the DMV 240) or oil changes and scheduled maintenance checks with dealership 220. Non-emergency information may also include normal (unexceptional or expected) vehicle operational information, such as fuel consumption rate, geographic location (e.g. via GPS receivers), temperature and so forth. Since the mobile app 200 includes (or integrates with) a calendar feature, many non-emergency activities can be scheduled there for improved ease of use for the vehicle owner.

Information in database 212 may be used to produce vehicle value estimates of improved accuracy, and these estimates may be displayed to the vehicle owner or communicated to the dealership 220 (either of whom may decide to investigate a transaction regarding the vehicle: the owner may decide to trade it in for a new vehicle, or the dealer may seek to add the vehicle to its used-car inventory).

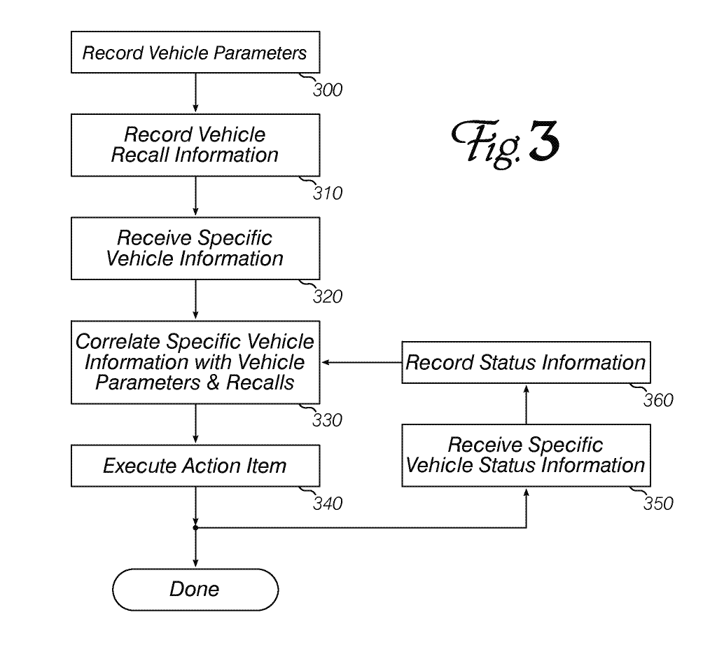

An automatic computer program implementing features according to an embodiment may operate along the lines depicted in FIG. 3:

In preparation for operation of an embodiment, and continuously or regularly during such operation, vehicle parameters are obtained (e.g., from manufacturers and other knowledgeable parties) and recorded in a database (300). Parameters include information such as the size, type, classification and available configurations of the vehicle, serial numbers used on the vehicle, and expected and required maintenance intervals (generally based on time/duration or mileage). Other information may include list prices, actual sale prices, or market indicators such as supply and demand of the vehicle.

The embodiment also continuously or regularly collects recall information about vehicles from manufacturers, government agencies, consumer protection testers, and so forth, and records this information in the database (310). Preferably, recall information (such as safety recall information) is examined manually to confirm that the vehicles it purports to apply to are actually correct.

Now, with respect to a particular vehicle, the system receives information to identify a vehicle as an instance of a known type or classification of vehicle (320). For example, specific vehicle information may include a model, year of manufacture, and information about the trim level, options, conditions, and owner. Often, much of this information may be encoded in a Vehicle Identification Number (“VIN”), so a preferred embodiment receives a bulk of the specific vehicle information as a VIN.

Next, the system correlates the specific vehicle information with the previously-recorded vehicle parameters and recall information to produce an action item (330). For example, if a newly-recorded specific vehicle has an outstanding safety recall, then the action item may be to notify the vehicle owner that service is required (or confirm that the service has been completed already). Finally, the action item is executed (340) by sending a message to a suitable party or scheduling an appointment to perform a service.

Subsequently, the system may receive additional status information about the specific vehicle (350). For example, vehicle location, operational parameters or environmental conditions may be transmitted. When new status information about a vehicle arrives, the system repeats the correlating step (330), and if a new action item is generated, it is executed (340). The reception and correlation steps may be repeated as often as desired.

It should be appreciated that many distinct “specific” vehicles can be registered in the system, and the streams of status data from each are handled similarly. In a preferred embodiment, only a single database of vehicle parameters and recall information need be maintained; similar specific vehicles can refer to the same parameter and recall information. Of course, differences in the status information received from each specific vehicle will typically result in different sequences of action items.

When a system similar to that depicted in FIG. 1 has been constructed, the operator can use software operating, for example, at central control computer 120 to implement a number of valuable use cases. (The important elements of the system include the special-purpose interface device 110 to collect information from the vehicle or mechanical system; a general-purpose computer configured with data and instructions to cause the interactions discussed below; information obtained from the plurality of databases 160 and 170; and one or more distributed data communication networks to support communication among these parts.)

First, when new safety recalls or notices are issued (i.e., when such information is obtained from one or more of the plurality of databases), the system can transmit a notification to the owner of an affected vehicle. This may be important if the current owner is not the original owner (e.g., if the current owner purchased the vehicle used)—the typical notification channels (manufacturer to [original] owner) may not be effective to alert the present owner of the vehicle. These notifications can include information about the severity of the recall, and any necessary warnings about operating the vehicle prior to repair.

Second, when the vehicle interface device reports an anomaly or fault condition, or when it reports a number of hours or miles operated that meets or exceeds a standard level obtained from the manufacturer's recommended service intervals, the system can notify the owner that preventative or corrective repair is necessary. Furthermore, an embodiment that comprises an interface to a service center's appointment calendar may schedule such maintenance semi-automatically by identifying times at which both the owner and the service center have available time. Alternatively, with access to a plurality of appointment calendars, an embodiment may identify days and times of mutual availability and present these to the owner for selection of a service time. The embodiment may then make one or more entries on the appointment calendars so that the service center knows to expect the owner and his vehicle at the selected time. The appointment may further include vehicle status or other information so that the service technician can prepare to perform the necessary service efficiently by stocking necessary parts or tools, or by learning or reviewing a repair procedure.

Third, an embodiment may schedule reminders for the vehicle owner (e.g., using the owner's electronic calendar or appointment book). Reminders include without limitation upcoming maintenance, insurance premium payments clue, driver's license/registration renewals, and vehicle safety or smog inspection renewals.

Fourth, an embodiment may keep records of maintenance actually performed (i.e., when the vehicle is serviced, the date, mileage and service notes may be communicated to and stored by the service operator). These maintenance logs may increase the resale value of the vehicle by allowing the seller to prove that the vehicle was maintained properly.

Fifth, an embodiment may provide a communication channel by which area service stations or authorized repair centers can present special pricing offers to owners for upcoming inspections and repairs.

Sixth, the system may provide an interface to dealers and service centers, integrating vehicle owners' maintenance information and availability so that they know when scheduled maintenance will likely come clue. Dealers may, on the basis of this information, proactively reach out to customers to offer special deals and pricing. This feature may also assist dealers with their vehicle acquisition needs, helping them match those needs with suitable quality levels of vehicles in their “extended inventory”-vehicles belonging to others that might nevertheless be available to a purchaser who approaches the dealer looking for a particular model.

An embodiment may also display information to the vehicle owner using the vehicle's own displays. In this arrangement, the central computer would transmit the information via the distributed data network and to the vehicle interface, which would pass it to the vehicle for suitable display. Information such as average miles per gallon, countdown to next scheduled maintenance (by time or mileage), “Check Engine Light”: codes and meanings may be displayed. The vehicle interface may also provide a “one-click” way to contact a service department and/or displaying scheduling options chosen by matching users'/repair centers' schedule availability.

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that mechanical status and maintenance records for devices including vehicles can also be produced by software and hardware that distribute the functions of embodiments of this invention differently than herein described. Such variations and implementations are understood to be captured according to the following claims.

We claim:

1. A method comprising:
recording vehicle parameters in a database;
recording safety recall information in the database;
receiving a specific vehicle identification from a vehicle and recording the specific vehicle information in the database;
correlating the specific vehicle information with the vehicle parameters and the safety recall information to produce an action item; and
executing the action item.

2. The method of claim 1, further comprising:
receiving status information from the vehicle;
recording the status information in the database; and
repeating the correlating and executing operations in view of the status information.

3. The method of claim 1 wherein the action item is a time-based maintenance event and executing the action item is scheduling an appointment to perform the time-based maintenance event.

4. The method of claim 1 wherein the action item is a mileage-based maintenance event and executing the action item is scheduling an appointment to perform the mileage-based maintenance event.

5. The method of claim 2 wherein the status information is an on-board diagnostic (“OBD”) alert.

6. The method of claim 2 wherein the status information is a geographic location of the vehicle.

7. The method of claim 2 wherein the status information is a crash sensor activation.

8. The method of claim 6 wherein the action item is to dispatch roadside assistance.

9. A system comprising:
a special-purpose interface device to receive operational information from a mechanical system;
a general-purpose computer configured with instructions and data to perform predetermined operations;
a database containing manufacturer and non-manufacturer information about the mechanical system; and
data communication means for transmitting the operational information from the special-purpose interface device to the general-purpose computer, wherein
the instructions and data cause the general purpose computer to correlate the operational information with the manufacturer and non-manufacturer information in the database and transmit a message based on the correlation to a receiving party.

10. The system of claim 9, wherein the message is an alert to an operator of the mechanical system.

11. The system of claim 9, wherein the message is an alert to an owner of the mechanical system.

12. The system of claim 9, wherein the mechanical system is a vehicle.

13. The system of claim 12 wherein the vehicle is an automobile.

14. The system of claim 9, wherein the message is an alert to a service center that performs maintenance on the mechanical system.

15. The system of claim 9, wherein the message schedules an appointment on an electronic calendaring system.

16. A computer-readable medium containing data and instructions to cause a programmable processor to perform operations comprising:
receiving maintenance information about a vehicle model from a plurality of sources and storing the maintenance information in a database;
registering vehicle owner information in the database, said vehicle owner information comprising a name and a contact address of the vehicle owner and model information of the vehicle owner's vehicle;
receiving status information from the vehicle owner's vehicle;
correlating the status information with the maintenance information in the database; and
transmitting a message based on the correlating operation to the vehicle owner at the contact address.

17. The computer-readable medium of claim 16, containing additional data and instructions to cause the programmable processor to perform operations comprising:
recording the status information in the database.

18. The computer-readable medium of claim 17, containing additional data and instructions to cause the programmable processor to perform operations comprising:
computing an estimated value of the vehicle owner's vehicle based on the information in the database; and
transmitting the estimated value to the vehicle owner at the contract address.

19. The computer-readable medium of claim 17, containing additional data and instructions to cause the programmable processor to perform operations comprising:
computing an estimated value of the vehicle owner's vehicle based on the information in the database; and
transmitting the estimated value to a vehicle dealership.

20. The computer-readable medium of claim 16 wherein the status information is at least one of:
a mileage traveled by the vehicle;
a number of hours of operation of the vehicle;
a speed of the vehicle;
a location of the vehicle; or
an abnormal mechanical condition detected by the vehicle.
